(19) United States
(12) Patent Application Publication
(10) Pub. No.: US 2007/0152367 A1
(43) Pub. Date: Jul. 5, 2007

(54) EPTFE PROCESS AND PRODUCT FOR MEDICAL APPLICATIONS

(76) Inventors: Valentin Kramer, Feldkirchen-Westerham (DE); Bruce G. Ruefer, Bozeman, MT (US)

Correspondence Address: LATHROP & GAGE LC, 2345 GRAND AVENUE, SUITE 2800, KANSAS CITY, MO, 64108, US

(21) Appl. No.: 11/685,315

(22) Filed: Mar. 13, 2007

Related U.S. Application Data
(63) Continuation of application No. 10/017,798, filed on Dec. 12, 2001.

(30) Foreign Application Priority Data
Dec. 13, 2000 (DE) 100 61 936.3

(51) Int. Cl. B29C 47/00

(52) U.S. Cl. 264/154; 264/210.6; 264/209.3; 264/323

(57) ABSTRACT

The invention described herein consists of an expanded PTFE (ePTFE) material that contains a novel fibril and node structure that exhibits a pore size distribution of two or more distinct pore sizes. The pore size distribution of small pores inter-spaced with larger pores to create a mosaic pore structure is advantageous as a blood-contacting surface and renders the invention a very useful and advantageous vascular graft.

### CROSS-REFERENCE TO RELATED APPLICATIONS

This application is a continuation of U.S. patent application Ser. No. 10/017,798 filed Dec. 13, 2000, the disclosure of which is incorporated herein by reference, which claims the benefit of German Patent Application No. 100 61 9363.3 filed Dec. 13, 2000, which has since issued as German Patent No. DE 601 05 532 issued Jan. 27, 2005, the entire contents of which are also herein incorporated by reference.

### FIELD OF THE INVENTION

The present invention relates generally to composite articles formed from expanded polytetrafluoroethylene (“ePTFE”) materials, and particularly to a composite article made up of a plurality of polytetrafluoroethylene (“PTFE”) components having differing expansion characteristics such that differing ePTFE structures are exhibited.

### BACKGROUND OF THE INVENTION

DE 690 03 879 describes a porous, at least uni-axially expanded PTFE material comprising a mixture of a PTFE having a high molecular weight of 2.000.000 or more and a PTFE having a low molecular weight of 1.000.000 or less. The size of the pores of the PTFE-material can be varied by changing the mixing ratio for the PTFE with high molecular weight and the PTFE with low molecular weight. The PTFE-material can exhibit different shapes, for example a foil, sheet or cube. Further, the PTFE-material can be used in different fields, for example as membrane filter exhibiting a low pressure loss as diaphragms, as smearing glide means and as bonding or sticking means, respectively.

Many similar designs of ePTFE tubes serving as vascular grafts (“grafts”) can be found in the market place. These designs range from a fairly simple uniaxially expanded ePTFE graft made into various bore sizes (W. L. Gore & Associates, Flagstaff, Ariz.) and lengths to more complex design of uniaxially expanded ePTFE tube reinforced with a ring complex made of fluorinated ethylene propylene (“FEP”) or ePTFE film (W. L. Gore & Associates, Flagstaff, Ariz.). In addition, double wall ePTFE grafts constructed as a “tube within a tube” can be found in the patent literature (U.S. Pat. No. 5,935,667). Most of these grafts are designed to exhibit a uniform structure of fibrils and nodes containing about 30 micron pores. This pore size is believed to be advantageous for blood contact, control bleeding, and make the graft adequately strong.

While the ePTFE vascular grafts are reported to be functional for their intended use, significant and novel design improvements are needed to address the known inadequacies of their designs that relate to optimum blood contact requirements, strength requirements, and pore size distribution. The invention disclosed herein accomplishes this goal.

### BRIEF DISCUSSION OF THE INVENTION

The invention described herein consists of an expanded PTFE (ePTFE) material that contains a novel fibril and node structure that exhibits a pore size distribution of two or more distinct pore sizes. The pore size distribution of small pores inter-spaced with larger pores to create a mosaic pore structure is advantageous as a blood-contacting surface and renders the invention a very useful and advantageous vascular graft, cardio vascular patch, cardio vascular suture, stent cover, and comparable medical devices and means.

The preferred invention disclosed herein consists of an ePTFE tube comprising two or more PTFE (polytetrafluoroethylene) resins that are blended, stretched, and sintered or locked into a novel fibril and node matrix. The tube is constructed to exhibit pores within the matrix of fibrils and nodes that exhibit two or more distinct size-distributions of pores. The preferred invention may be reinforced with an outer wrapping of a Fluorinated Ethylene Propylene (FEP) filament configured into a double helix structure. The advantages of the preferred invention will come forth as the details are disclosed herein.

According to a most preferred embodiment of the invention, there are provided at least two distinct groups of pores in the ePTFE (expanded polytetrafluoroethylene). A first group consists of pores the sizes of which are in, and preferably cover, the range of 2 micron to 15 micron, preferably in the range from 3 micron to 8 micron, most preferably in the range from 4 micron to 6 micron, in particular around 5 micron. A second group consists of pores having sizes which are in, and preferably cover, the range from 20 micron to 50 micron, in particular in the range from 25 to 40 micron, most preferably the range from 25 to 35 micron, in particular around 30 micron.

The afore-mentioned at least two distinct groups of pores are preferably randomly distributed in the ePTFE tube material. The smaller pores are found within the larger pores, according to a statistical (random) distribution of pores.

As to the number of pores of smaller size as compared to the number of pores of larger size, the afore-mentioned preferred embodiment comprising at least two distinct groups of pores, the invention discloses a ratio of number of pores per volume unit of expanded PTFE of the first group and the number of pores per volume unit of expanded PTFE of the second group, said ratio being selected in the range from 0,2 to 5, preferably 0,4 to 3, most preferably in the range of 0,6 to 2, in particular the ratio can have a value of 1+0,2.

The afore-mentioned embodiment of the invention comprising at least two distinct groups, and preferably two distinct groups, has turned out to be most efficient with regard to the above stated problem.

The invention also discloses a second embodiment of ePTFE tubes, also serving in particular as vascular grafts, cardio vascular patches, cardio vascular sutures, stent covers, and comparable medical devices and means said second embodiment being characterized in that all pores have sizes distributed in the range from 2 micron to 50 micron, preferably in the range from 4 micron to 40 micron, most preferably in the range from 5 micron to 30 micron. That distribution can be homogeneous in the stated range or it can be in accordance with a statistical distribution, like a Gaussian curve.

The preferred invention may be constructed in a variety of shapes and sizes, with or without the reinforcing wrapping as specific need dictates.

### DETAILED DESCRIPTION OF THE DRAWINGS

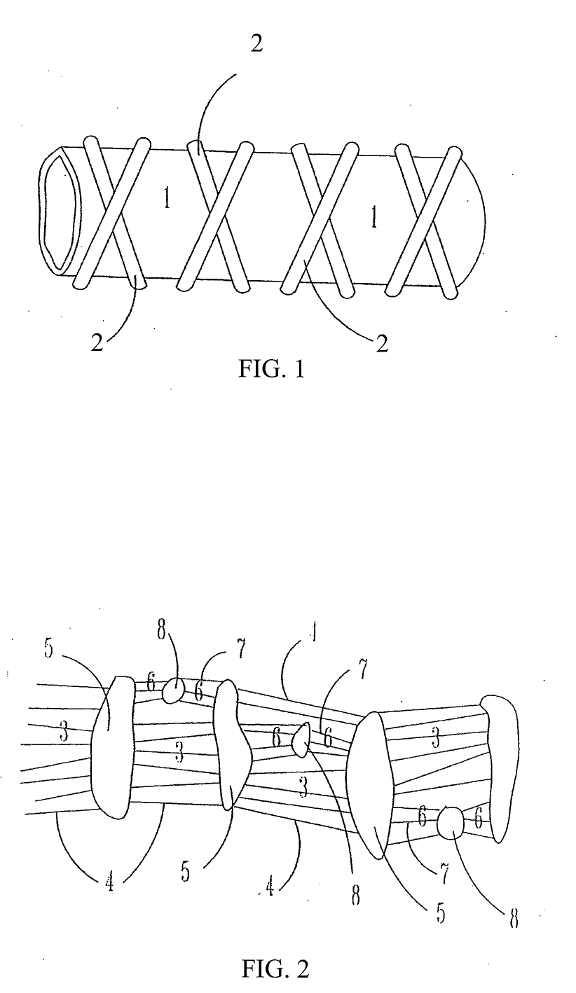

FIG. 1 is a two-dimensional drawing showing the ePTFE tube with outer reinforcing wrapping of the preferred invention.

FIG. 2 a two-dimensional drawing showing the novel bi-pore mosaic structure of the preferred invention.

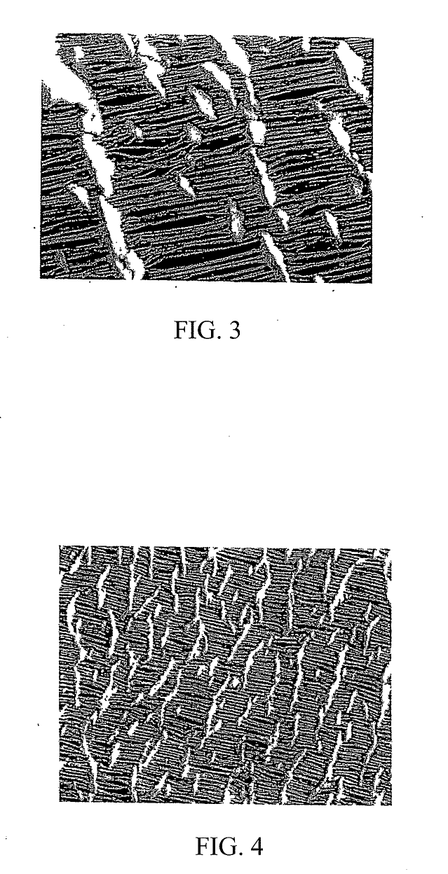

FIG. 3 is a 500× scanning electron micrograph (SEM) of the novel bi-pore mosaic ePTFE structure of the preferred invention.

FIG. 4 is a 100× scanning electron micrograph (SEM) of the novel bi-pore mosaic ePTFE structure of the preferred invention.

### DETAILED DESCRIPTION

FIG. 1 depicts a two-dimensional overview drawing of the preferred invention showing the novel ePTFE tube 1 with a FEP filament wrap 2 reinforcing the tube.

FIG. 2 shows a close up two-dimensional drawing of the preferred invention showing two distinct pore size distributions. The larger pores 3 are shown as a distribution within the structure and contain long fibril structures 4 connected between large solid PTFE node structures 5. The small pores 6 are shown as a distribution within the larger pores 3 and are shown containing short fibril structures 7 connected between small solid PTFE node structures 8 and other small solid PTFE node structures or, as shown in FIG. 2, large solid PTFE node structures 5. The smaller pore size distributions are found within the larger pore size distribution in a random manner forming a bi-pore mosaic overall structure. As is shown in FIG. 2, a cross-section through the material displays first areas of the smaller pore size distribution and second areas distinct from the smaller pore size areas, the second areas being larger, according to the larger pore size distribution. The ratio of the first and second areas (each area measured in μm²) is preferably selected from the range of 1:5 to 1:1.

FIG. 3 is a scanning electron micrograph (SEM) of the novel structure of the preferred invention at 500×. The SEM shows the two distinct pore size distributions forming a mosaic pore structure advantageous for the invention.

FIG. 4 is a scanning electron micrograph (SEM) of the novel structure of the preferred invention at 100×. The SEM depicts more closely the two distinct pore size distributions forming a mosaic pore structure advantageous for the invention.

The preferred invention is made in the following manner: Two PTFE resins are chosen based on the following properties. (1) A resin that expands to exhibit a relatively small pore size distribution of about 5 microns. (2) A resin that expands to exhibit a relatively large pore size distribution of about 30 microns. The resins are mixed homogenously to about a 1:1 ratio and then blended with a lubricant. The resultant paste is formed into a billet with medium pressure in a pelletizer apparatus. The billet is extruded into a tube. The resultant extruded PTFE tube is then expanded with heat to make the ePTFE structure. The resultant ePTFE tube is reinforced with an outer FEP filament wrap configured into a double helix structure. The reinforced tube is heat treated to fuse the FEP filament to the outer portion of the ePTFE tube.

In the afore-mentioned general description of the preferred embodiment, the ratio of 1:1 of the two resins can be varied in certain ranges, preferably the weight ratio can be varied in the range from 0,5:1 to 2:1, most preferably in the range from 0,75:1 to 1,25:1. Furthermore, the resins can be selected to produce other pore sizes, the most preferred ranges being stated above.

The resulting ePTFE tube exhibits the following properties: The inner wall and surface structure of the ePTFE tube exhibits a mosaic bi-pore structure of fibrils and nodes. The novel bi-pore mosaic ePTFE tube is a structure exhibiting two distinct pore size distributions found to be randomly interspaced one within the other.

### EXAMPLE I

Two polytetrafluoroethylene (PTFE) resins are selected according to their expansion characteristics as follows:

(1) A high molecular weight grade of resin (about 3 million Daltons) is selected to select for small pore sizes of about 5 microns.

(2) A low molecular weight grade of resin (about 1 million Daltons) is selected to select for large pore sizes of about 30 microns. The resins are weighed to make a ratio of about 50/50 by weight and are simultaneously blended with a lubricant until thoroughly mixed and coated with lubricant. The resultant resin paste is then made into a billet per standard practice with a billet making apparatus called a pelletizer. The billet is then warmed to about 35° C. and is inserted into a ram extruder. Forcing the PTFE billet through a die with high-pressure forms a PTFE tube. The tube is then expanded in a linear manner at about the melt point of the PTFE of about 350° C. The resultant expanded PTFE (ePTFE) tube is then cut to various lengths. The tubes are reinforced with FEP helix wrapping by inserting a precision stainless tube into the ePTFE tube and then wrapping the FEP onto the ePTFE tube. The FEP wrapping is secured to the underlying ePTFE tube by heating the assembly in an oven at or near the melting point of the FEP.

The resulting ePTFE tubes are examined and show the following characteristics:

(1) a fibril and node structure containing two distinct pore size distributions wherein one is found within another; and

(2) A very flexible tube showing excellent resistance to kinking upon bending at 180 degrees.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method of making a PTFE article, comprising:
providing a first resin having a first molecular weight;
providing a second resin having a second molecular weight, said second molecular weight being substantially higher than said first molecular weight;
mixing said first and second resins together along with a lubricant to form a blend;
extruding the blend into a shaped member;
expanding the shaped member at a first temperature, said first temperature being about the crystalline melt temperature of PTFE; and
providing said article as a medical implant device for use in blood-contact applications.

2. The method of claim 1 wherein said extruding step comprises:
warming the billet to about 35° C. and passing it through a die to form a PTFE tube.

3. The method of claim 1 comprising:
setting said first temperature during said expanding step to be about 350° C.

4. The method of claim 1 comprising:
forming the blend into a billet before said extruding step.

5. The method of claim 1 comprising:
selecting said first resin such that it has a molecular weight of about 1 million Daltons.

6. The method of claim 5 comprising:
selecting said second resin such that it has a molecular weight of about 3 million Daltons.

7. A method of making a PTFE article, comprising:
providing a first resin having a first property;
providing a second resin having a second property;
mixing said first and second resins together to form a blend;
forming the blend into a shaped member;
expanding the shaped member at an elevated temperature such that first property causes the article to have a first group of pores, and such that said second property causes the article to have a second group of pores which are larger than said first group of pores.

8. The method of claim 7 comprising:
creating a value for said first property of said first resin such that said first group of pores will have sizes in the range of 2 to 15 microns; and
creating a value for said second property of said second resin such that said second group of pores will have sizes in the range of 20 and 50 microns.

9. The method of claim 7 comprising:
creating a value for said first property of said first resin such that said first group of pores will have sizes in the range of 3 to 8 microns; and
creating a value for said second property of said second resin such that said second property will cause said first group of pores will have sizes in the range of 25 and 40 microns.

10. The method of claim 7 comprising:
creating a value for said first property of said first resin such that said first group of pores will have sizes of about 5 microns; and
creating a value for said second property of said second resin such that said second group of pores will have sizes of about 30 microns.

11. The method of claim 7 comprising:
executing said forming step at a slightly raised temperature.

12. The method of claim 11 comprising:
setting said slightly raised temperature at about 35 degrees.

13. The method of claim 7 comprising:
extruding the blend through a die to accomplish said forming step.

14. The method of claim 7 comprising:
setting said elevated temperature during said expanding step to be about the crystalline melt temperature of PTFE.

15. The method of claim 14 comprising:
causing said elevated temperature to be about 350° C.

16. The method of claim 7 comprising:
providing said article, when completed, as a medical implant device for use in blood-contact applications.

17. The method of claim 7 comprising:
forming the blend into a billet before executing said extruding step.

18. The method of claim 7 comprising:
selecting said first resin such that it has a molecular weight of about 1 million Daltons and said second resin such that it has a molecular weight of about 3 million Daltons.

19. The method of claim 7 comprising:
including substantially equal amounts of said first and second resins in said blend by weight ratio.

20. The method of claim 7 comprising:
wherein a weight ratio of the first and second resins is in the range of from 0,5:1 to 2:1.

21. The method of claim 7 comprising:
wherein a weight ratio of the first and second resins is in the range of from 0,75:1 to 1,25:1.

22. A process comprising:
mixing a first PTFE resin having a molecular weight of about 1 million Daltons with a second PTFE resin having a molecular weight of about 3 million Daltons;
mixing said first and second resins together along with a lubricant to form a blend;
forming a billet using said blend;
extruding the billet through a die to form a tubular member;
expanding the tubular member at about the crystalline melt temperature of PTFE;
structurally reinforcing said article by including it in a supportive filament wrap; and
providing said article as a medical implant device for use in blood-contact applications.
